(19) United States
(12) Patent Application Publication
(10) Pub. No.: US 2026/0356520 A1
(43) Pub. Date: Nov. 12, 2026

(54) LAUNCHING CONTAINER USING SUPPORTS FOR MOBILE PLATFORMS

(71) Applicant: Perennial Autonomy, LLC, Menlo Park, CA (US)

(72) Inventors: Christian Johan Owen HANDLEY, San Francisco, CA (US); Michael Shane WILKERSON, Summerville, SC (US)

(21) Appl. No.: 19/672,471

(22) Filed: May 8, 2026

Related U.S. Application Data
(63) Continuation-in-part of application No. 19/542,624, filed on Feb. 17, 2026.
(60) Provisional application No. 63/803,081, filed on May 9, 2025.
(60) Provisional application No. 63/807,413, filed on May 16, 2025.
(60) Provisional application No. 63/815,810, filed on Jun. 1, 2025.
(60) Provisional application No. 63/854,392, filed on Jul. 30, 2025.
(60) Provisional application No. 63/910,760, filed on Nov. 3, 2025.
(60) Provisional application No. 63/960,687, filed on Jan. 14, 2026.

(51) Int. Cl. B64U 80/70; B64U 70/50; B64U 80/40

(52) U.S. Cl. CPC B64U 80/70; B64U 70/50; B64U 80/40

(57) ABSTRACT

A launching container for mobile platforms includes a body extending a length from a first end to a second end. The body includes an interior compartment that is configured to receive a stack of at least two mobile platforms therein. The first end of the body includes an opening configured to enable the mobile platforms to be launched from the interior compartment of the body through the opening. The launching container includes a support extending within the interior compartment. The support is configured to engage in physical contact with at least one of the mobile platforms to hold the mobile platform within the interior compartment of the body.

### CROSS-REFERENCE TO RELATED APPLICATIONS

This non-provisional utility application claims priority to provisional patent application No. 63/807,413, entitled “LAUNCHING CONTAINER USING SUPPORTS FOR MOBILE PLATFORMS” and filed on May 16, 2025, provisional patent application No. 63/803,081, entitled “MOBILE PLATFORM DEPLOYMENT METHOD AND SYSTEM” and filed on May 9, 2025, provisional patent application No. 63/815,810, entitled “LAUNCHING CONTAINER ASSEMBLY FOR MOBILE PLATFORMS” and filed on Jun. 1, 2025, provisional patent application No. 63/854,392, entitled “DUAL-PURPOSE BOOT AND METHOD OF MANUFACTURE” and filed on Jul. 30, 2025, provisional patent application No. 63/960,687, entitled “CONTAINER ASSEMBLY WITH SECURING MECHANISM” and filed on Jan. 14, 2026, provisional patent application No. 63/910,760, entitled “MOBILE PLATFORM STACKING ASSEMBLY” and filed on Nov. 3, 2025, and non-provisional patent application Ser. No. 19/542,624, entitled “STACKING SPACER FOR MOBILE PLATFORMS” and filed on Feb. 17, 2026, each of which is incorporated herein in its entirety by reference.

### BACKGROUND

Existing methods and systems for deploying mobile platforms (e.g., rotor craft, fixed-wing, other uncrewed and/or autonomous aircraft, etc.) exhibit a variety of technical disadvantages.

### SUMMARY

In an aspect, a launching container for mobile platforms includes a body extending a length from a first end to a second end. The body includes an interior compartment that is configured to receive a stack of at least two mobile platforms therein. The first end of the body includes an opening configured to enable the mobile platforms to be launched from the interior compartment of the body through the opening. The launching container includes a support extending within the interior compartment. The support is configured to engage in physical contact with at least one of the mobile platforms to hold the mobile platform within the interior compartment of the body.

In another aspect, a launching container assembly includes first and second mobile platforms and a container extending a length from a first end to a second end. The container includes an interior compartment that is configured to receive a stack of the first and second mobile platforms therein. The first end of the container includes an opening configured to enable the first and second mobile platforms to be sequentially launched from the interior compartment of the container through the opening. The first mobile platform rests on the second mobile platform within the interior compartment.

In another aspect, a method includes configuring a launching container for launch, wherein the launching container contains a stack of first and second mobile platforms, and sequentially launching the first and second mobile platforms from the launching container.

### BRIEF DESCRIPTION OF THE DRAWINGS

FIG. 1 is an isometric schematic view illustrating a launching container assembly according to an implementation.

FIG. 2 is an elevational schematic view of a launching container assembly according to an implementation.

FIG. 3 is a plan schematic view of the launching container assembly shown in FIG. 2 according to an implementation.

FIG. 4 is an elevational schematic view of a launching container assembly according to an implementation.

FIG. 5 is a plan schematic view of the launching container assembly shown in FIG. 2 according to an implementation.

FIG. 6 is an elevational schematic view of a launching container assembly according to an implementation.

FIG. 7 is an isometric schematic view of a launching container assembly according to an implementation.

FIG. 8 illustrates isometric and elevational schematic views of an example of a carrying pack of a launching container assembly according to an implementation.

FIG. 9 is a flowchart illustrating a method of operation of a launching container assembly according to an implementation.

### DETAILED DESCRIPTION

Existing methods and systems for deploying mobile platforms (e.g., rotor craft, fixed-wing, other uncrewed and/or autonomous aircraft, etc.) exhibit a variety of technical disadvantages. In one example, known methods and systems struggle to coordinate the deployment of a plurality of mobile platforms. For example, known methods and systems struggle to provide adequate support during transport and launch of a group of mobile platforms. One example includes the mobile platforms being damaged from misalignment and/or other movement of the mobile platforms during transit. Another example includes the misalignment and/or other movement of the mobile platforms (e.g., during transport, etc.) causing damage during launch of the mobile platforms and/or resulting in one or more of the mobile platforms failing to launch as intended.

In contrast, aspects of the disclosure provide a launching container assembly for stacking, transporting, and launching mobile platforms using a launching container. Aspects of the disclosure provide supports that facilitate holding a stack of the mobile platforms in alignment within the launching container. In some examples, the mobile platforms are configured to mate and/or nest with each other within the launch container. The launching container assembly supports synchronized or sequential mobile platform deployment, with designs enabling post-launch detachment of the supports, for example based on desired flight dynamics. In some examples, a body of the launching container is modular such that the body is connectable, stackable, and/or the like with one or more other launching containers.

Aspects of the disclosure are operable in a range of applications including, but not limited to, agricultural monitoring and management, disaster response and/or recovery, environmental conservation and/or monitoring, urban infrastructure inspection, scientific research and/or mapping, telecommunication and/or network deployment, logistical support and/or delivery, construction and/or maintenance, and/or the like.

Examples of agricultural monitoring and/or management applications include enabling relatively rapid deployment of mobile platforms for crop monitoring, pest control, irrigation management across relatively expansive farmland, and/or the like. For example, the mobile platforms can be deployed sequentially or simultaneously to cover relatively large areas, for example providing data on plant health and/or soil conditions.

An example of a disaster response and/or recovery application includes deploying mobile platforms in emergency situations from the stacked configuration, for example to assess damage, deliver aid materials, search for survivors, and/or the like. The quicker launch capability provided by aspects of the disclosure enables immediate response and/or real-time data collection to support recovery efforts.

Environmental conservation and/or monitoring applications include equipping mobile platforms with sensors to monitor wildlife, track deforestation, inspect remote ecosystems, and/or the like, which for example may streamline environmental surveys and/or conservation efforts by facilitating relatively rapid data collection across relatively large and/or varied terrains.

An urban infrastructure inspection example includes relatively efficient inspection of bridges, power lines, other critical infrastructure within urban environments, and/or the like. Multiple mobile platforms can be launched to cover relatively large and/or relatively complex structures, for example ensuring thorough and/or timely inspection efforts.

In a scientific research and/or mapping application, researchers can use stacked mobile platforms for geospatial mapping, atmospheric sampling, wildlife observation, and/or the like, which may aid in collecting data over relatively extensive and/or relatively difficult-to-access areas, for example enhancing research accuracy and scope.

Telecommunication and/or network deployment applications include, but are not limited to, using mobile platforms to establish temporary communication networks in relatively remote and/or underserved regions, which for example may enable for the relatively rapid setup of relay stations, signal boosters, and/or the like (e.g., facilitating communication and/or connectivity).

Examples of logistical support and/or delivery applications include supporting the distribution of goods in logistics and/or delivery applications (e.g., in relatively crowded and/or relatively difficult-to-reach urban areas, etc.). For example, mobile platforms can be launched in a coordinated sequence to perform delivery tasks relatively efficiently and/or relatively reliably.

In a construction and/or maintenance application example, mobile platforms can perform tasks at construction sites such as, but not limited to, surveying, progress monitoring, equipment inspection, and/or the like. The stacked deployment of the mobile platforms enables relatively efficient management of multiple mobile platform operations on-site, for example aiding in project management and/or maintenance.

In a military application example, multiple mobile platforms may be deployed more rapidly to perform operations.

Aspects of the disclosure operate in an unconventional manner at least by providing a launching container for mobile platforms that includes a body extending a length from a first end to a second end. The body includes an interior compartment that is configured to receive a stack of at least two mobile platforms therein. The first end of the body includes an opening configured to enable the mobile platforms to be launched from the interior compartment of the body through the opening. The launching container includes a support extending within the interior compartment. The support is configured to engage in physical contact with at least one of the mobile platforms to hold the mobile platform within the interior compartment of the body.

Aspects of the disclosure operate in an unconventional manner at least by providing a launching container assembly that includes first and second mobile platforms and a container extending a length from a first end to a second end. The container includes an interior compartment that is configured to receive a stack of the first and second mobile platforms therein. The first end of the container includes an opening configured to enable the first and second mobile platforms to be sequentially launched from the interior compartment of the container through the opening. The first mobile platform rests on the second mobile platform within the interior compartment.

Aspects of the disclosure operate in an unconventional manner at least by providing a method that includes configuring a launching container for launch, wherein the launching container contains a stack of first and second mobile platforms, and sequentially launching the first and second mobile platforms from the launching container.

The technical effects of the launching container assemblies disclosed herein include providing improved mobile platform launches. For example, aspects of the disclosure provide the technical solution of a more robust and stable launching platform that enables the technical effect of more precise and controlled deployment of mobile platforms. In one example, the technical solutions of the disclosed supports, the disclosed mating features, and the disclosed nesting features provides a greater amount of support during transport and launch of a group of mobile platforms, for example as compared to known deployment methods and systems. The greater amount of support provides the technical effects of reducing and/or preventing: misalignment, damage (e.g., to the mobile platforms, etc.), launch mishaps, launch failures, and/or the like. For example, the disclosed supports, mating features, and nesting features provide the technical effects of reducing and/or preventing misalignment of the mobile platforms during transport and maintaining alignment at launch of the mobile platforms. Moreover, the technical solution of the disclosed modularity of the launch containers disclosed herein provides, for example, the technical effect of enabling the construction of a larger stack and/or grid of individual launching containers.

Examples of mobile platforms (e.g., mobile platform 104, etc.) include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), aquatic vehicles (e.g., boats, ships, marine vehicles, freshwater vehicles, etc.), surface vehicles, submersibles, uncrewed aquatic vehicles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), missiles, rockets, uncrewed mobile platforms, autonomous mobile platforms, and/or the like. In some examples, a launching container assembly as disclosed herein is used with one or more uncrewed, autonomous platforms.

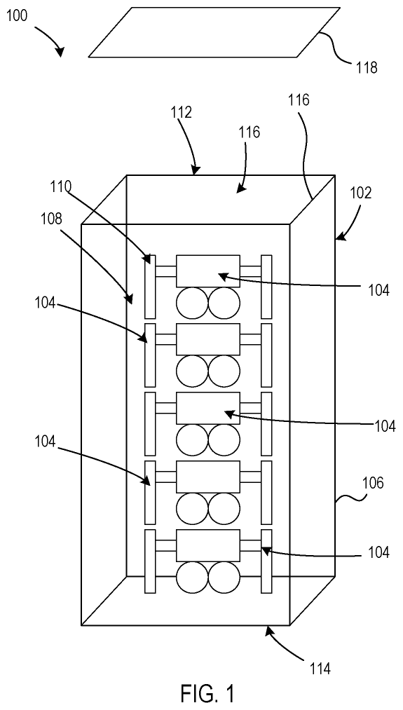

Referring to the figures, FIG. 1 is an isometric schematic view illustrating an exemplary implementation of a launching container assembly 100. The launching container assembly 100 includes a launching container 102 and mobile platforms 104. The launching container 102 includes a body 106 that includes an interior compartment 108 that is configured to hold a stack 110 of the mobile platforms 104 therein. As will be described below, and for example, the stack of mobile platforms 104 is held within the interior compartment 108 such that the mobile platforms 104 rest on each other and/or are supported by one or more supports (not shown in FIG. 1). Each of the mobile platforms 104 may be referred to herein as a “first” and/or a “second” mobile platform.

The body 106 of the launching container 102 extends a length from an end 112 to an end 114. The body 106 includes an opening 116 at the end 112 and/or at the end 114 that opens the interior compartment 108. The opening 116 enables the mobile platforms 104 to exit the interior compartment 108 therethrough during launch of the mobile platforms 104 from the launching container 102. Optionally, the body 106 includes a cover, lid, and/or top 118 that at least partially covers the opening 116, for example to protect the stack 110 and/or seal the interior compartment 108 during transport, storage, and/or the like. The cover, lid, and/or top 118 may provide tip-over protection, camouflage, environmental protection (e.g., from dust, dirt, water, sand, debris, etc.), and/or the like. The cover, lid, and/or top 118 is selectively removable, releasable, detachable, openable, and/or the like to enable the mobile platforms 104 to exit the launching container 102 through the opening 116 (e.g., during launch thereof, etc.). Each of the ends 112 and 114 may be referred to herein as a “first” and/or a “second” end. The opening 116 may be referred to herein as an “exit” of the launching container 102.

In the exemplary implementation of FIG. 1, the end 114 is closed, for example to provide a bottom of the launching container 102. In some other examples, the body 106 of the launching container 102 includes an opening at the end 114 (in addition or alternatively to the opening 116 at the end 112), for example to enable the mobile platforms 104 to launch through the end 114.

The stack 110 of mobile platforms 104 is configured to be launched (e.g., deployed, etc.) directly from the launching container 102. In other words, each mobile platform 104 is configured to be launched directly from the stack 110 and directly from the interior compartment 108 of the launching container 102. For example, a mobile platform 104 may launch directly from the interior compartment 108 of the launching container 102 by moving (e.g., exiting, leaving, flying, etc.), under its own power, through the opening 116 at the end 112 of the launching container 102. In an exemplary implementation wherein the mobile platforms 104 are UAVs, the mobile platforms 104 may launch directly from the launching container 102 by flying through the opening 116 under their own power. In some examples, direct launch of a mobile platform 104 from the launching container 102 is assisted by facilitating (e.g., initiating, boosting, replacing, propelling, etc.) the acceleration of the mobile platform 104 off the stack 110 and through the opening 116, for example by spring loading the mobile platforms 104, using a linear motor device (e.g., a rail gun, etc.), using a catapult (e.g., a steam catapult, a mechanical catapult, a pneumatic catapult, etc.), using a propellant (e.g., a fuel, a rocket fuel, a solid fuel, a liquid fuel, a gaseous fuel, a liquid propellant, a solid propellent, a gaseous propellant, a gas turbine engine, a jet, a propeller, an airfoil, etc.), using a pneumatic launcher, using a push and/or pull device (e.g., hydraulic, mechanical, pneumatic, electromechanical, etc.), using an ejection device, and/or the like. In some examples, one or more of the mobile platforms 104 is removed from the stack 110 before being deployed, for example manually, automatically, autonomously, and/or the like.

In some examples, the mobile platforms 104 are held within the interior compartment 108 of the launching container 102 for storage and/or transport of the mobile platforms 104. For example, the stack 110 of the mobile platforms 104 may be stored using the launching container 102 (e.g., within a building or other structure, within a cave and/or other underground area, outside, etc.) for later use. In another example, the launching container assembly 100 is loaded onto another mobile platform (e.g., a vehicle, a mothership, a backpack and/or other carrying pack, a human, an animal, etc.) and transported to another location, for example for deployment of one or more of the mobile platforms 104 from the launching container 102 at the other location.

Although five are shown, the stack 110 may include any number of mobile platforms 104. In an exemplary implementation, the launching container 102 and the stack 110 are approximately vertical such that the mobile platforms 104 are configured to launch vertically from the launching container 102. In other implementations, the launching container 102 and/or the stack 110 may additionally or alternatively extend approximately horizontal and/or an at oblique angle.

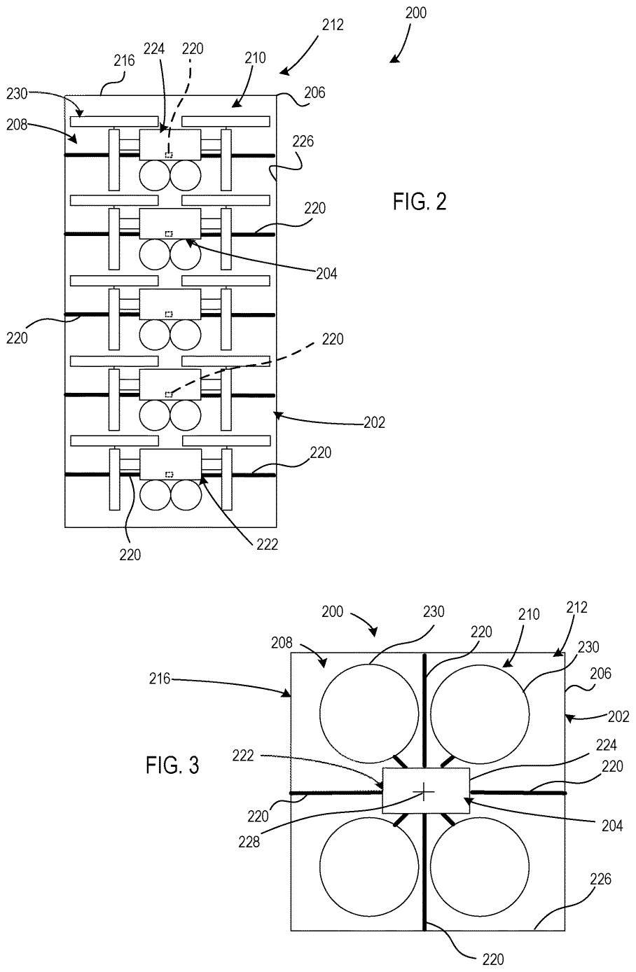

FIGS. 2 and 3 illustrate elevational and plan schematic views, respectively, of a launching container assembly 200 according to an implementation. The launching container assembly 200 includes a launching container 202 and a stack 210 of mobile platforms 204 held within an interior compartment 208 of a body 206 of the launching container 202. An end 212 of the body 206 of the launching container 202 includes an opening 216 that enables the mobile platforms 204 to exit the interior compartment 208 therethrough during launch of the mobile platforms 204 from the launching container 202. The end 212 may be referred to herein as a “first” and/or a “second” end. The opening 216 may be referred to herein as an “exit” of the launching container 202.

The launching container 202 includes supports 220 that extend within the interior compartment 208. Each support 220 is configured to engage in physical contact with a corresponding mobile platform 204 to facilitate holding the mobile platform 204 within the interior compartment 208 of the launching container 202. For example, as shown in FIGS. 2 and 3, ends 222 of the supports 220 are engaged in physical contact with airframes 224 of the mobile platforms 204, though each support 220 may additionally or alternatively engage in physical contact with any other portion of the corresponding mobile platform 204. Each support 220 is configured to release from the corresponding mobile platform 204 to enable the mobile platform 204 to exit the interior compartment 208 through the opening 216 during launch of the mobile platform 204 from the launching container 202.

In some examples, the supports 220 are configured to facilitate spacing the mobile platforms 204 apart from each other within the stack 210. For example, the positions of the supports 220 within the internal compartment 208 of the launching container 202 may be configured (e.g., selected, etc.) such that the supports 220 hold the mobile platforms 204 in a configuration that spaces the mobile platforms 204 apart from adjacent (e.g., above, below, etc.) mobile platforms 204 within the stack 210.

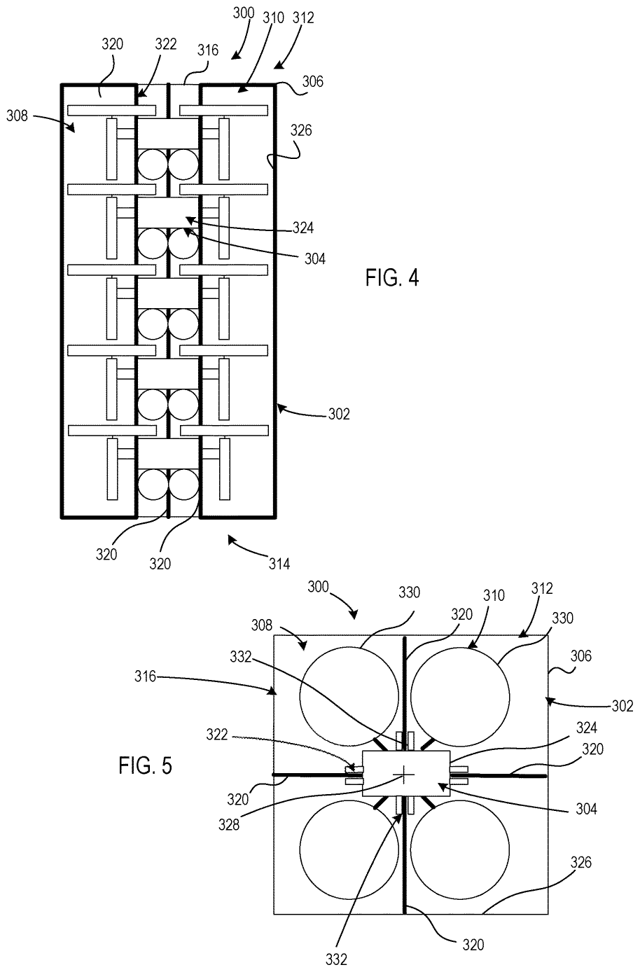

In the exemplary implementation of FIGS. 2 and 3, each support 220 includes an elongate lateral member that extends radially inwardly within the interior compartment 208 of the body 206 of the launching container 202. For example, the supports 220 shown in FIGS. 2 and 3 include a plurality of elongate members that extend from an interior side (e.g., surface, wall, etc.) 226 of the launching container 202 radially inward toward a central longitudinal axis 228 of the launching container 202. Any other geometry, configuration, number, and/or the like of the supports 220 may additionally or alternatively be used (e.g., the supports 320 shown in FIGS. 4 and 5, etc.). Although four are shown, the launching container 202 may include any other number of the supports 220. Each of the supports 220 may be referred to herein as a “lateral” support.

In some examples, the engagement of one or more of the supports 220 in physical contact with the corresponding mobile platform 204 is configured to connect the support 220 to the corresponding mobile platform 204. For example, the end 222 of one or more of the supports 220 may be configured to connect with the airframe 224 of the corresponding mobile platform 204. The connection between the support 220 and the corresponding mobile platform 204 facilitates holding the corresponding mobile platform 204 in position within the interior compartment 208 of the launching container 202 and facilitates holding the corresponding mobile platform 204 in alignment within the stack 210. The connection between the support 220 and the corresponding mobile platform 204 is one example of a configuration that may be used to facilitate spacing the mobile platforms 204 apart from each other within the stack 210.

Connections between the supports 220 and the mobile platforms 204 may be provided by any type, configuration, arrangement, geometry, structure, construction, means, method, and/or the like that enables the supports 220 to release from the mobile platforms 204 during launch of the mobile platforms 204. Examples of connectors that enable the supports 220 to connect with the mobile platforms 204 include, but are not limited to, break-away connectors, hinges, magnets, magnetic connectors, latches, interference fit connectors, press fit connectors, clearance fit connectors, pressure connectors, clamps, snap fit connectors, releasable connectors, mating features, and/or the like.

Examples of break-away connectors that may be used to connect the supports 220 to the mobile platforms 204 include connectors having frangible segments that are configured to separate during launch of the corresponding mobile platform 204 such that the mobile platform 204 breaks free and release (e.g., separates, etc.) from the corresponding support(s) 220 by moving towards the opening 216 of the launching container 202. Another example of a connector for connecting the supports 220 to the mobile platforms 204 include magnetic connectors that include magnets that magnetically connect one or more supports 220 to the corresponding mobile platform 204. The magnetic connection may be overcome by the corresponding mobile platform 204 moving toward the opening 216 such that the mobile platform 204 and support 220 release from each other. Pressure connectors that may be used to connect the supports 220 to the mobile platforms 204 include, but are not limited to: connectors that provide an interference, clearance, and/or press fit between the support 220 and the corresponding mobile platform 204 (e.g., a length of the support 220 is adjustable to provide an interference, clearance, and/or press fit between the corresponding mobile platform 204 and the interior side 226 of the launching container 202, etc.); connectors that provide a stiction and/or friction fit between the support 220 and the corresponding mobile platform 204 (e.g., the length of the support 220 is adjustable to provide a stiction and/or friction fit between the corresponding mobile platform 204 and the interior side 226, etc.); clamps; and/or the like. The connection provided by pressure connectors may also be overcome by the corresponding mobile platform 204 moving toward the opening 216 such that the support 220 releases from the corresponding mobile platform 204. Snap fit connectors are another example of a connection between the supports 220 and the mobile platforms 204 that may be overcome by the force of the mobile platform 204 moving toward the opening 216, such that the support 220 releases from the corresponding mobile platform 204. In some examples, one or more supports 220 and/or mobile platforms 204 includes a releasable latch for connecting the support 220 to the corresponding mobile platform 204. For example, the releasable latch may be manually, selectively, and/or automatically released at launch to enable the mobile platform 204 and support to release from each other.

Optionally, one or more supports 220 and/or mobile platforms 204 includes mating features that connect one or more supports 220 to the corresponding mobile platform 204. For example, the mating features may facilitate stability of the stack 210 during transport and/or enable release of the mobile platforms 204 from the corresponding support(s) 220 for individual launch. The mating features may include any type, configuration, arrangement, geometry, structure, construction, means, method, fastener, fit, mechanism, and/or the like that enables the mating features to mate together, such as, but not limited to, pins, sockets, recessed contours, projections, magnets, extensions, openings, clips, latches, clamps, c-clamps, springs, spring-loaded fasteners, hook and loop fasteners, rails, grooves, slots, straps, and/or the like. In some examples, the mating features mate together with an interference, clearance, snap, and/or press-fit.

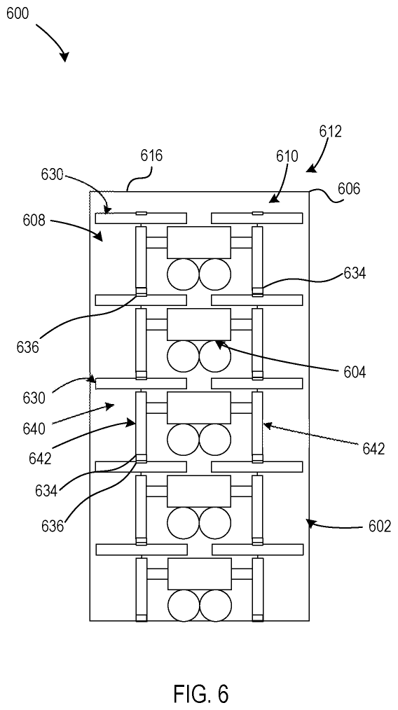

In some examples, the engagement of one or more of the supports 220 in physical contact with the corresponding mobile platform 204 does not connect the support 220 to the corresponding mobile platform 204, but rather the engagement facilitates holding the corresponding mobile platform 204 in the interior compartment 208 in alignment within the stack 210. For example, the end 222 of the support 220 may provide a stop surface that limits movement of the corresponding mobile platform 204 within the interior compartment 208 (e.g., with a relatively tight fit between supports 220 that does not allow much relative movement of the corresponding mobile platform 204, with a relatively loose fit between supports 220 that enables the mobile platform 204 to float relative to the supports 220, etc.). While the engagement in physical contact of the support 220 with the corresponding mobile platform 204 facilitates holding the corresponding mobile platform 204 in alignment, the corresponding mobile platform 204 may be held within the interior compartment 208 using another component, such as, but not limited to, using one or more other supports that connects with the corresponding mobile platform 204, via the corresponding mobile platform 204 resting on and/or nesting with an adjacent mobile platform 204 within the stack 210 (e.g., as shown in the launching container assembly 600 shown of FIG. 6, etc.), via a spacer extending between the corresponding mobile platform 204 and an adjacent mobile platform 204 within the stack 210, and/or the like.

In some examples, and for example as is shown in FIGS. 2 and 3, the support(s) 220 of a corresponding mobile platform 204 that has launched are configured to fit between rotors 230 of successive mobile platforms 204 that are below the corresponding mobile platform 204 in the stack 210 during launch of the successive mobile platforms 204 (i.e., as the successive mobile platforms 204 move through the interior compartment 208 toward the opening 216). In addition or alternatively, one or more supports 220 may be configured to fall out of the way within the interior compartment 208 after releasing from the corresponding mobile platform 204, for example utilizing gravity, a hinge, and/or the like.

FIGS. 4 and 5 illustrate elevational and plan schematic views, respectively, of a launching container assembly 300 according to an implementation. The launching container assembly 300 includes a launching container 302 and a stack 310 of mobile platforms 304 held within an interior compartment 308 of a body 306 of the launching container 302. An end 312 of the body 306 of the launching container 302 includes an opening 316 that enables the mobile platforms 304 to exit the interior compartment 308 therethrough during launch of the mobile platforms 304 from the launching container 302. The body 306 of the launching container 302 extends a length from the end 312 to an end 314. Each of the ends 312 and 314 may be referred to herein as a “first” and/or a “second” end. The opening 316 may be referred to herein as an “exit” of the launching container 302.

The launching container 302 includes supports 320 that extend within the interior compartment 308. Each support 320 is configured to engage in physical contact with a corresponding mobile platform 304 to facilitate holding the mobile platform 304 within the interior compartment 308 of the launching container 302. For example, as shown in FIGS. 4 and 5, ends 322 of the supports 320 are engaged in physical contact with airframes 324 of the mobile platforms 304, though each support 320 may additionally or alternatively engage in physical contact with any other portion of the corresponding mobile platform 304.

In the exemplary implementation of FIGS. 4 and 5, each support 320 includes a fin that extends within the interior compartment 308 along at least a portion of the length of the body 306. For example, each support fin 320 extends from an interior side 326 of the body 306 radially inwardly toward a central longitudinal axis 328 of the body 306. In the exemplary implementation of FIGS. 4 and 5, the supports 320 include a plurality of fins that extend radially inwardly toward the central longitudinal axis 328 of the launching container 302. Although four are shown, the launching container 302 may include any other number of the support fins 320. As can be seen in FIG. 4, the exemplary implementation of the supports 320 includes fins that extend along an approximate entirety of the length of the body 306; however, in other implementations one or more of the support fins 320 extends along only a portion of the length of the body 306. Any other geometry, configuration, number, and/or the like of the supports 320 may additionally or alternatively be used. Each of the supports 320 may be referred to herein as a “lateral” support.

Each mobile platform 304 is configured to slide along the support fins 320 to enable to enable the mobile platform 304 to launch from the launching container 302. For example, the mobile platforms 304 are configured to slide relative to the support fins 320 as the mobile platforms 304 move within the interior compartment 308 toward the opening 316 such that the mobile platforms 304 can exit the interior compartment 308 through the opening 316. Optionally, the support fins 320 (e.g., the ends 322, etc.) are received within corresponding grooves 332 (not shown in FIG. 4) of the mobile platforms 304. The reception of the support fins 320 within the grooves 332 facilitates guiding the mobile platforms 304 as the mobile platforms move through interior compartment 308 toward the opening 316. As shown in FIGS. 4 and 5, the support fins 320 are configured to extend and fit between rotors 330 of the mobile platforms 304.

In the exemplary implementation of FIGS. 4 and 5, the engagement of one or more of the support fins 320 in physical contact with the mobile platform 304 does not connect the support fins 320 to the mobile platforms 304, but rather the engagement facilitates guiding the mobile platforms 304 and/or holding the mobile platforms 304 in the interior compartment 308 in alignment within the stack 310. For example, the ends 322 of the support fins 320 may provide stop surfaces that limit movement of the mobile platform 304 within the interior compartment 308 (e.g., with a relatively tight fit between support fins 320 that does not allow much relative movement of the mobile platforms 304, with a relatively loose fit between support fins 320 that enables the mobile platforms 304 to float relative to the support fins 320, etc.). While the engagement in physical contact of the support fins 320 with the mobile platforms 304 facilitates guiding and/or holding the mobile platforms 304 in alignment, the mobile platforms 304 may be held within the interior compartment 308 using another component, such as, but not limited to, using one or more other supports that connects with the mobile platforms 304, via the mobile platforms 304 resting on and/or nesting with adjacent mobile platforms 304 within the stack 310 (e.g., as shown in the launching container assembly 600 shown of FIG. 6, etc.), via spacers extending between the mobile platforms 304 within the stack 310, and/or the like.

In some examples, the engagement of one or more of the support fins 320 in physical contact with the mobile platforms 304 is configured to connect the support fin 320 to the mobile platform 304, for example via connectors of the support fins 320 that are located on the support fins 320 at locations along the length of the interior compartment 308 that correspond to the positions of the mobile platforms 304 within the stack 310. For example, the end 322 of one or more of the support fins 320 may be configured to connect with the airframe 324 of the mobile platforms 304. The connection between the support fin 320 and the mobile platforms 304 facilitates holding the mobile platforms 304 in position within the interior compartment 308 of the launching container 302 and facilitates holding the mobile platforms 304 in alignment within the stack 310. The connection between the support fin 320 and the mobile platforms 304 is one example of a configuration that may be used to facilitate spacing the mobile platforms 304 apart from each other within the stack 310.

Connections between the support fins 320 and the mobile platforms 304 may be provided by any type, configuration, arrangement, geometry, structure, construction, means, method, and/or the like that enables the support fins 320 to release from the mobile platforms 304 during launch of the mobile platforms 304 and enables successive mobile platforms 304 to slide relative to the support fins 320 as the successive mobile platforms 304 launch from the launching container 302. Examples of connectors that enable the support fins 320 to connect with the mobile platforms 304 include, but are not limited to, break-away connectors, hinges, magnets, magnetic connectors, latches (e.g., a releasable latch, etc.), interference fit connectors, press fit connectors, clearance fit connectors, pressure connectors, clamps, snap fit connectors, releasable connectors, mating features, and/or the like.

FIG. 6 illustrates an elevational schematic view of a launching container assembly 600 according to an implementation. The launching container assembly 600 includes a launching container 602 and a stack 610 of mobile platforms 604 held within an interior compartment 608 of a body 606 of the launching container 602. An end 612 of the body 606 of the launching container 602 includes an opening 616 that enables the mobile platforms 604 to exit the interior compartment 608 therethrough during launch of the mobile platforms 604 from the launching container 602. The end 612 may be referred to herein as a “first” and/or a “second” end. The opening 616 may be referred to herein as an “exit” of the launching container 602.

In addition or alternatively to the supports 220 (FIGS. 2 and 3) and/or the supports 320 (FIGS. 4 and 5), the mobile platforms 604 may rest on adjacent (e.g., below, etc.) mobile platforms 604 within the interior compartment 608 when the mobile platforms 604 are stacked together in the stack 610 within the interior compartment 608, for example as is shown in FIG. 6. Optionally, the mobile platforms 604 are configured to nest with adjacent mobile platforms 604 when the mobile platforms 604 are arranged in the stack 610 within the interior compartment 608. For example, the mobile platforms 604 may include mating features 634 and 636 that enable adjacently stacked mobile platforms 604 to nest together within the stack 610. For example, one or more segments (e.g., a payload bracket, a payload arm, a payload holder, a rotor arm, a rotor holder, an airframe, a base, a housing, a skin, a shell, an exterior structure, etc.) of each of the mobile platforms 604 includes the mating features 634 and 636. In some examples, the mating features 634 and 636 are configured to space the mobile platform 604 from the adjacent mobile platforms 604 within the stack 610. Further, and for example, opposite sides of the segment of the mobile platform 604 may include the mating features 634 and 636 to enable the mobile platform 604 to mate with adjacent mobile platforms 604 within the stack 610.

In the exemplary implementation of FIG. 6, the mobile platforms 604 include propeller assemblies 640 that enable nesting of the mobile platforms 604 in the stack 610. For example, each propeller assembly 640 includes a propeller 630 and an accompanying boot 642 positioned beneath the propeller 630. Each boot 642 includes the mating feature 634 for detachably connecting to the mating feature 636 that extends on a top portion of a corresponding propeller assembly 640 of the adjacent mobile platform 604 that is below (e.g., underneath, etc.) in the stack 610. The mating features 634 and 636 are configured to enhance the stability of the stacked mobile platforms 604 during transport and to enable the separation of the mobile platforms 604 for independent launches. In some examples, the mating features 634 and 636 include magnets incorporated into the structure of each propeller 630 and boot 642, respectively. When the mobile platforms 604 are stacked, the magnets of the mating features 634 and 636 are aligned and mated together. The magnetic connection ensures that the mobile platforms 604 remain aligned and stable in the stack 610. The nesting action facilitates the stackability and stability of the platform assembly.

Other connection mechanisms that enable nesting, aside from magnets, are contemplated for use in addition or alternative to the magnets. For example, the mating features 634 may include recessed contours that correspond to projections of the mating features 636 on the top surfaces of the propeller assemblies 640, such that the “feet” of one mobile platform 604 nest snugly onto the propeller assembly 640 of the adjacent mobile platform 604 that is below within the stack 610. Other examples that may be additionally or alternatively used include, but are not limited to, a pin and socket system, an automated and/or manually actuated release feature to separate the mating features 634 and 636, hook and loop fastening strips (e.g., the mobile platforms 604 can be fitted with hook and loop fasteners on their upper and lower surfaces, etc.), an interlocking rail and/or groove system (e.g., with a sliding and/or hinge mechanism to facilitate detachment of the mating features 634 and 636, etc.), a slot-based system, a strapping system (e.g., wherein straps can be loosened and/or cut using a quick-release mechanism, etc.), and/or the like. For example, hook and loop fasteners may be designed to shear off cleanly upon activation of a release mechanism.

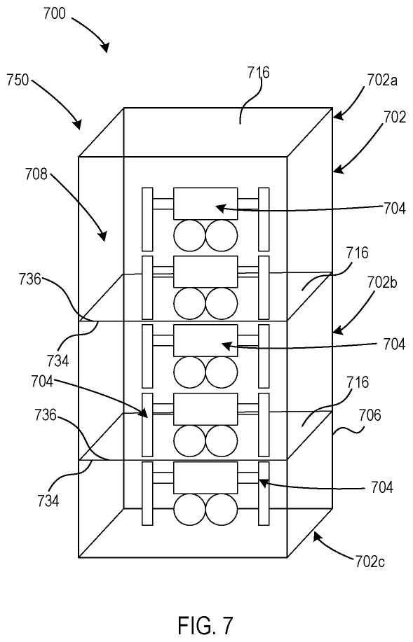

Referring now to FIG. 7, in some examples, the body of the launching container is modular such that the body is connectable, stackable, and/or the like with one or more other launching containers. For example, FIG. 7 illustrates a launching container assembly 700 includes a plurality of modular launching containers 702 (i.e., the launching containers 702a, 702b, and 702c, etc.) that are stacked together into a vertical stack 750 of the launching containers 702. Each launching container 702a, 702b, and 702c may include any number of mobile platforms 704. Although shown having three, the stack 750 may include any number of launching containers 702. In addition or alternative to the vertical stack 750, the modular launching containers 702 may be connected together horizontally (e.g., palletized, etc.) into a grid of a plurality of the launching containers 702.

In some examples, the mobile platforms 704 are launched directly from the stack 750. For example, bodies 706 of the launching containers 702 include openings 716 that enable the mobile platforms 704 to move through a combined interior compartment 708 of the stack 750 and exit the launching container assembly 700 through the opening 716 of the launching container 702a. Optionally, and for example when the launching container assembly 700 is used merely for storage and/or transport, the opening 716 of one or more of the launching containers 702 is closed. Each of the openings 716 may be referred to herein as an “exit” of the corresponding launching container 702.

The body 706 of one or more of the launching containers 702 optionally includes one or more mating features that are configured to mate with a corresponding mating feature of another launching container 702 to connect the launching containers 702 together into the stack 750 and/or a grid. For example, the body 706 of the launching container 702a includes a mating feature 734 that mates with a corresponding mating feature 736 of the body 706 of the launching container 702b to connect the launching containers 702a and 702b together; and the body 706 of the launching container 702b includes a mating feature 734 that mates with a corresponding mating feature 736 of the body 706 of the launching container 702c to connect the launching containers 702b and 702c together.

The mating features of the launching containers 702 may have any type, configuration, arrangement, geometry, structure, construction, means, method, fastener, fit, mechanism, and/or the like that enables the mating features to function as described herein (e.g., connect the launching containers 702 together into the stack 750 and/or a grid, provide a relatively rigid attachment between launching containers 702, etc.). Examples of the mating features of the launching containers 702 include, but are not limited to, pins, sockets, recessed contours, projections, magnets, extensions, openings, clips, latches, clamps, c-clamps, springs, spring-loaded fasteners, hook and loop fasteners, rails, grooves, slots, straps, and/or the like. In some examples, the mating features of the launching containers 702 mate together with an interference, clearance, snap, and/or press-fit. In one example of a mating feature for connecting launching containers 702 together into a grid, one or more of the launching containers 702 may include a flap that when opened is configured to mate with an adjacent launching container 702.

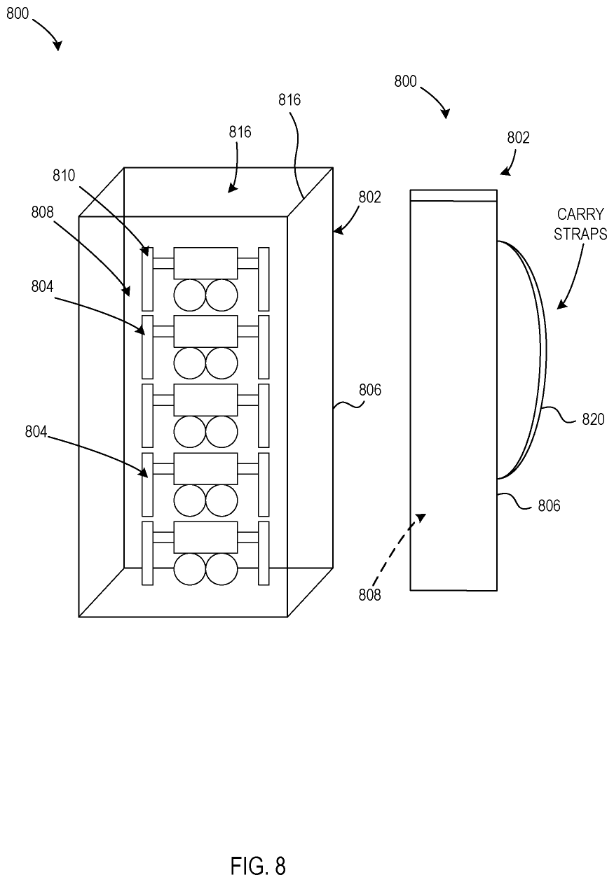

FIG. 8 illustrates one non-limiting example of a stack 810 of mobile platforms 804 being held by a carrying pack 806. For example, FIG. 8 illustrates a launching container assembly 800 that includes a launching container 802 and the stack 810 of mobile platforms 804. The launching container 802 includes a body 806 that includes an opening 816 and an interior compartment 808 that is configured to hold the stack 810 therein. As shown in FIG. 8, the body 806 of the launching container 802 is configured as a carrying pack 806 that is configured to be carried, for example by an individual, a mobile platform, and/or the like. For example, the body 806 of the launching container 802 includes one or more straps 820 that enable the body 806 to be carried. The opening 816 may be referred to herein as an “exit” of the launching container 802.

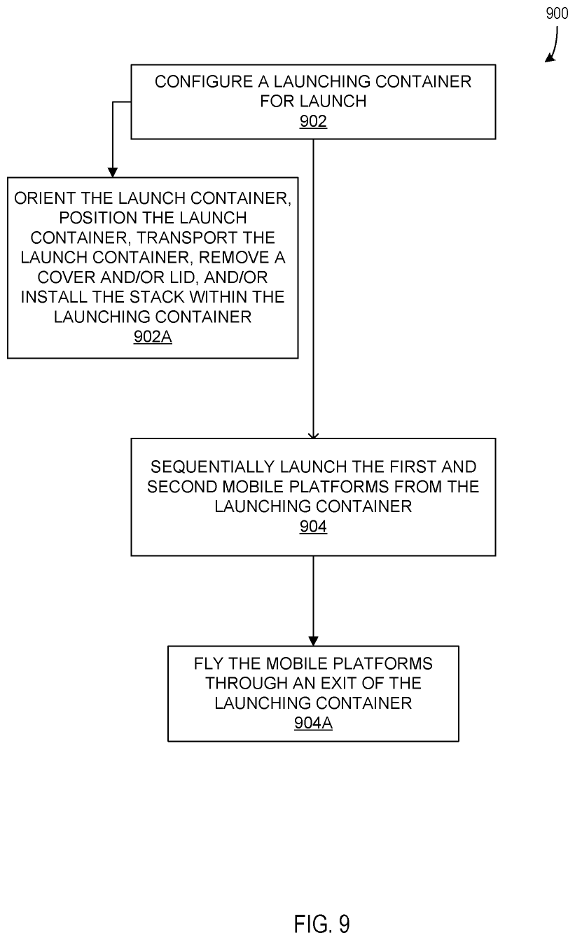

FIG. 9 is a flowchart illustrating an example of a method 900. At 902, the method 900 includes configuring a launching container for launch, wherein the launching container contains a stack of first and second mobile platforms. At 904, the method 900 includes sequentially launching the first and second mobile platforms from the launching container. Optionally, configuring at 902 the launching container for launch includes, at 902A, orienting the launching container, positioning the launching container, transporting the launching container, removing at least one of a cover or a lid of the launching container, and/or installing the stack of the first and second mobile platforms within the launching container. Sequentially launching at 904 the first and second mobile platforms from the launching container optionally includes flying, at 904A, the first and second mobile platforms through an exit of the launching container.

### FURTHER IMPLEMENTATIONS

In some examples, a spacer system is provided that includes employing spacer elements of predefined thickness positioned between mobile platforms within the launching container to maintain an approximately uniform separation, for example during alignment, during transport, to ensure adequate separation for relatively efficient deployment and/or collision avoidance during transport and/or launch, and/or the like. The spacers may be made from relatively lightweight materials and/or be designed to snap onto and/or slide between mobile platforms, for example ensuring relatively consistent spacing while providing stability during transport.

In another example, a suspension system is utilized to facilitate separation between adjacent mobile platforms. For example, each mobile platform may be attached to a suspension mechanism such as, but not limited to, tensioned cables, elastic bands, and/or the like. Such a suspension system allows mobile platforms to remain suspended at predetermined intervals, for example minimizing contact and/or ensuring individual clearances. The suspension system can provide vertical separation, for example enabling mobile platforms to remain distinct during transit, launch, deployment, and/or the like.

A rotary arm system is another exemplary separation implementation. For example, a rotary arm mechanism may include mobile platforms positioned on rotating arms fixed to a central mounting hub. The arms may extend radially, for example maintaining horizontal separation between mobile platforms, and/or allowing for relatively efficient organization. In some examples, upon deployment (e.g., launch, etc.), the arms pivot and/or retract to release the mobile platforms (e.g., sequentially, synchronously, etc.) without interference.

Another implementation includes a telescopic separation system. For example, a telescopic rod configuration may be provided wherein mobile platforms are attached at various segments to provide a scalable means to separate the mobile platforms. For example, each segment corresponds to a mobile platform attachment point. As the rod is extended, mobile platforms are distanced appropriately (e.g., incrementally separated, etc.), for example adequate spacing necessary for ensuring unobstructed launch pathways.

A rack and pinion system is another example. An example of a rack and pinion system involves mounting each mobile platform on an individual platform with rack gears, for example which is movable across the horizontal plane via pinon activation. The platforms can be moved apart by actuating the pinion gears, for example maintaining relatively precise separations, enabling relatively precise control over the separation between mobile platforms, ensuring clear launch paths, and/or facilitating controlled deployment.

In some implementations, the simultaneous launch of vertically stacked mobile platforms may be facilitated (e.g., assisted, etc.) through the integration of synchronized release mechanisms. A synchronized release system including synchronized release mechanisms is capable of achieving a synchronized release, for example providing simultaneous launch capability for vertically stacked drones, thereby optimizing their deployment and operational efficiency. Such synchronized release mechanisms include, but are not limited to, coordinated release systems, pyrotechnic separation devices, electromagnetic release mechanisms, mechanical interlock systems, pneumatic liberation systems, hydraulic release systems, and/or the like.

In an example of a coordinated release system, supports (e.g., the supports 220 shown in FIGS. 2 and 3, the supports 320 shown in FIGS. 4 and 5, etc.) may be equipped with an actuator that releases the mobile platform upon receiving a synchronized signal, which can be transmitted wirelessly and/or via a wired connection. Examples of pyrotechnic separation devices include small pyrotechnic charges strategically placed within each support. Upon activation, the pyrotechnic charges can break the connections at precisely the same moment, for example allowing all mobile platforms to initiate launch concurrently. Electromagnetic release mechanism examples include, but are not limited to, electromagnets within the supports to secure the mobile platforms in place, wherein activation of the electromagnets via a simultaneous electrical signal will release all mobile platforms at once.

An example of a mechanical interlock system includes releasing a series of mechanical linkages that hold each mobile platform in place using one or more mechanical actions. For example, pulling a central pin and/or lever connected to interlock mechanisms disengages the mobile platforms simultaneously. In an example of a pneumatic liberation system, pressurized air can be used to create a forceful release of the mobile platforms. For example, a system of pneumatic pistons, bladders, and/or the like may simultaneously push each mobile platform out of its support upon activation, for example ensuring concurrent deployment. A hydraulic release system example includes employing hydraulic actuators, with a central hydraulic system providing simultaneous release pressure to all mobile platforms. The mobile platforms, attached via hydraulic couplings, are ejected by synchronized hydraulic force.

### EXAMPLES

Aspects of the disclosure include a launching container for mobile platforms that includes a body extending a length from a first end to a second end. The body includes an interior compartment that is configured to receive a stack of at least two mobile platforms therein. The first end of the body includes an opening configured to enable the mobile platforms to be launched from the interior compartment of the body through the opening. The launching container includes a support extending within the interior compartment. The support is configured to engage in physical contact with at least one of the mobile platforms to hold the mobile platform within the interior compartment of the body.

In some examples, the mobile platforms include a first mobile platform and a second mobile platform and the support is configured to space the first mobile platform apart from the second mobile platform when the first and second mobile platforms are stacked together within the interior compartment.

Optionally, the support includes a fin extending within the interior compartment along at least a portion of the length of the body. The fin extends from an interior side of the body radially inwardly toward a central longitudinal axis of the body. The fin is configured to be received within grooves of the mobile platforms.

In some examples, the support at least one of: includes a fin extending along at least a portion of the length of the body, wherein the fin extends between rotors of at least one of the mobile platforms; is configured to fit between the rotors of at least one of the mobile platforms during launch thereof; or is configured to hold at least two of the mobile platforms in alignment with each other within the stack.

In some examples, the support is configured to be releasably connected to at least one of the mobile platforms.

Optionally, the support includes at least one of a lateral support, a structure that extends radially inwardly within the interior compartment, an elongate member that extends radially inwardly within the interior compartment, a releasable latch that connects the support to at least one of the mobile platforms, a plurality of radially inwardly extending supports, a break-away connector, a hinge, a magnet, a magnetic connector, a latch, a clearance fit connector, an interference fit connector, a press fit connector, a pressure connector, a clamp, or a snap fit connector.

In some examples, at least one of the mobile platforms includes a mating feature that is configured to mate with another mobile platform when the mobile platforms are stacked together within the interior compartment.

Optionally, the body is at least one of modular, connectable with another launching container, stackable with another launching container, or configured to mate with another launching container.

Optionally, the mobile platform includes a UAV.

In some examples, the mobile platforms are configured to be launched from the interior compartment through the opening under power of the mobile platforms.

Aspects of the disclosure include a launching container assembly that includes first and second mobile platforms and a container extending a length from a first end to a second end. The container includes an interior compartment that is configured to receive a stack of the first and second mobile platforms therein. The first end of the container includes an opening configured to enable the first and second mobile platforms to be sequentially launched from the interior compartment of the container through the opening. The first mobile platform rests on the second mobile platform within the interior compartment.

In some examples, at least one of: the first and second mobile platforms are configured to mate together; or the first and second mobile platforms nest with each other within the stack.

In some examples, each of the first and second mobile platforms includes a propeller assembly having a propeller and a boot positioned thereunder. The boot of the first mobile platform includes a mating feature for detachably connecting to a top of the propeller assembly of the second mobile platform.

In some examples, the container includes a support extending within the interior compartment. The support is configured to engage in physical contact with the first mobile platform to hold the first mobile platform within the interior compartment of the container.

Optionally, the container includes a support that includes a fin extending within the interior compartment along at least a portion of the length of the container. The fin extends from an interior side of the container radially inwardly toward a central longitudinal axis of the container. The fin is configured to be received within a groove of each of the first and second mobile platforms.

In some examples, the container includes a support extending within the interior compartment. The support includes at least one of a lateral support that extends radially inwardly within the interior compartment of the container, a break-away connector, a hinge, a magnet, a magnetic connector, a latch, a clearance fit connector, an interference fit connector, a press fit connector, a pressure connector, a clamp, or a snap fit connector.

Optionally, the container includes a support that is configured to be connected to the first mobile platform to hold the first mobile platform within the interior compartment. The support is configured to release from the first mobile platform to enable the first mobile platform to be launched from the interior compartment of the container.

Aspects of the disclosure include a method that includes configuring a launching container for launch, wherein the launching container contains a stack of first and second mobile platforms, and sequentially launching the first and second mobile platforms from the launching container.

In some examples, configuring the launching container for launch includes at least one of orienting the launching container, positioning the launching container, transporting the launching container, removing at least one of a cover or a lid of the launching container, or installing the stack of the first and second mobile platforms within the launching container.

Optionally, sequentially launching the first and second mobile platforms from the launching container includes flying the first and second mobile platforms through an exit of the launching container.

Aspects of the disclosure include a launching container for a mobile platform. The launching container includes a body extending a length from a first end to a second end. The body includes an interior compartment that is configured to receive the mobile platform therein. The first end of the body includes an opening configured to enable the mobile platform to exit the interior compartment of the body therethrough. The launching container includes a support extending within the interior compartment. The support is configured to engage in physical contact with the mobile platform to hold the mobile platform within the interior compartment of the body.

In some examples, the interior compartment of the body is configured to receive a stack of at least two of the mobile platforms therein.

Optionally, the mobile platform is a first mobile platform and the support is configured to space the first mobile platform apart from a second mobile platform when the first and second mobile platforms are stacked together within the interior compartment.

In some examples, the support includes a fin extending within the interior compartment along at least a portion of the length of the body. The fin extends from an interior side of the body radially inwardly toward a central longitudinal axis of the body.

In some examples, the support includes a fin extending within the interior compartment along at least a portion of the length of the body. The fin is configured to be received within a groove of the mobile platform to at least one of align or guide the mobile platform within the interior compartment of the body.

Optionally, the support includes a fin extending along at least a portion of the length of the body, the fin extending between rotors of the mobile platform.

In some examples, the support is configured to be connected to the mobile platform to hold the mobile platform within the interior compartment. The support is configured to release from the mobile platform to enable the mobile platform to exit the interior compartment of the body during launch of the mobile platform.

Optionally, the support includes at least one of a break-away connector, a hinge, a magnet, a magnetic connector, a latch, a clearance fit connector, an interference fit connector, a press fit connector, a pressure connector, a clamp, or a snap fit connector.

Optionally, the support includes an elongate member that extends radially inwardly within the interior compartment of the body.

Optionally, at least one of: the mobile platform is configured to rest on another mobile platform within the interior compartment when the mobile platform and the other mobile platform are stacked together within the interior compartment; or another mobile platform is configured to rest on the mobile platform within the interior compartment when the mobile platform and the other mobile platform are stacked together within the interior compartment.

In some examples, the mobile platform includes a mating feature that is configured to mate with another mobile platform when the mobile platform and the other mobile platform are stacked together within the interior compartment.

In some examples, the mobile platform is configured to nest with another mobile platform when the mobile platforms are arranged in a stack within the interior compartment.

Optionally, the mobile platform includes a set of propeller assemblies each having a propeller and a boot positioned thereunder. Each boot includes a mating feature for detachably connecting to a top of a corresponding propeller assembly of another mobile platform when the mobile platform and the other mobile platform are stacked together within the interior compartment.

In some examples, at least one of the support or the mobile platform includes a mating feature that facilitates stability of a stack of the mobile platforms during transport and allows separation of the mobile platforms for individual launch.

In some examples, the support includes a releasable latch that connects the support to the mobile platform.

In some examples, the support includes a plurality of radially inwardly extending supports.

In some examples, the mobile platform is a first mobile platform and the support is configured to fit between rotors of a second mobile platform during launch of the second mobile platform.

Optionally, the support is configured to hold the mobile platform in alignment within a stack of the mobile platform with at least one other mobile platform.

Optionally, the body is at least one of modular, connectable with another launching container, or stackable with another launching container.

In some examples, the body includes a mating feature that is configured to mate with another launching container.

Optionally, the mobile platform comprises a UAV.

Aspects of the disclosure include a launching container assembly that includes first and second mobile platforms, and a container extending a length from a first end to a second end. The container includes an interior compartment that is configured to receive a stack of the first and second mobile platforms therein. The first end of the body includes an opening configured to enable the first and second mobile platforms to sequentially exit the interior compartment of the body therethrough. The first mobile platform rests on the second mobile platform within the interior compartment.

Optionally, the first mobile platform includes a mating feature that mates with the second mobile platform.

Optionally, the first and second mobile platforms nest with each other within the stack.

Optionally, each of the first and second mobile platforms includes a propeller assembly having a propeller and a boot positioned thereunder. The boot of the first mobile platform includes a mating feature for detachably connecting to a top of the propeller assembly of the second mobile platform.

In some examples, the container includes a support extending within the interior compartment. The support is configured to engage in physical contact with the first mobile platform to hold the first mobile platform within the interior compartment of the body.

Optionally, the container includes a support that includes a fin extending within the interior compartment along at least a portion of the length of the container. The fin extends from an interior side of the container radially inwardly toward a central longitudinal axis of the container.

Optionally, the container includes a fin extending within the interior compartment along at least a portion of the length of the container. The fin is configured to be received within a groove of each of the first and second mobile platforms to at least one of align or guide the first and second mobile platform within the interior compartment.

In some examples, the container includes a lateral support that extends radially inwardly within the interior compartment of the container.

In some examples, the container includes a support that is configured to be connected to the first mobile platform to hold the first mobile platform within the interior compartment. The support is configured to release from the first mobile platform to enable the first mobile platform to exit the interior compartment of the container during launch of the first mobile platform.

In some examples, the container includes a support extending within the interior compartment. The support includes at least one of a break-away connector, a hinge, a magnet, a magnetic connector, a latch, a clearance fit connector, an interference fit connector, a press fit connector, a pressure connector, a clamp, or a snap fit connector.

Aspects of the disclosure include a method that includes configuring a launching container for launch, wherein the launching container contains a stack of first and second mobile platforms, and sequentially launching the first and second mobile platforms from the launching container.

Optionally, configuring the launching container for launch includes at least one of orienting the launching container, positioning the launching container, transporting the launching container, removing at least one of a cover or a lid of the launching container, or installing the stack of the first and second mobile platforms within the launching container.

In some examples, sequentially launching the first and second mobile platforms from the launching container includes flying the first and second mobile platforms through an exit of the launching container.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A launching container for mobile platforms, the launching container comprising:
a body extending a length from a first end to a second end, the body comprising an interior compartment that is configured to receive a stack of at least two mobile platforms therein, wherein the first end of the body comprises an opening configured to enable the mobile platforms to be launched from the interior compartment of the body through the opening; and
a support extending within the interior compartment, wherein the support is configured to engage in physical contact with at least one of the mobile platforms to hold the mobile platform within the interior compartment of the body.

2. The launching container of claim 1, wherein the mobile platforms comprise a first mobile platform and a second mobile platform and the support is configured to space the first mobile platform apart from the second mobile platform when the first and second mobile platforms are stacked together within the interior compartment.

3. The launching container of claim 1, wherein the support comprises a fin extending within the interior compartment along at least a portion of the length of the body, the fin extending from an interior side of the body radially inwardly toward a central longitudinal axis of the body, the fin being configured to be received within grooves of the mobile platforms.

4. The launching container of claim 1, wherein the support at least one of:
comprises a fin extending along at least a portion of the length of the body, wherein the fin extends between rotors of at least one of the mobile platforms;
is configured to fit between the rotors of at least one of the mobile platforms during launch thereof; or
is configured to hold at least two of the mobile platforms in alignment with each other within the stack.

5. The launching container of claim 1, wherein the support is configured to be releasably connected to at least one of the mobile platforms.

6. The launching container of claim 1, wherein the support comprises at least one of a lateral support, a structure that extends radially inwardly within the interior compartment, an elongate member that extends radially inwardly within the interior compartment, a releasable latch that connects the support to at least one of the mobile platforms, a plurality of radially inwardly extending supports, a break-away connector, a hinge, a magnet, a magnetic connector, a latch, a clearance fit connector, an interference fit connector, a press fit connector, a pressure connector, a clamp, or a snap fit connector.

7. The launching container of claim 1, wherein at least one of the mobile platforms comprises a mating feature that is configured to mate with another mobile platform when the mobile platforms are stacked together within the interior compartment.

8. The launching container of claim 1, wherein the body is at least one of modular, connectable with another launching container, stackable with another launching container, or configured to mate with another launching container.

9. The launching container of claim 1, wherein the mobile platform comprises an uncrewed aerial vehicle (UAV).

10. The launching container of claim 1, wherein the mobile platforms are configured to be launched from the interior compartment through the opening under power of the mobile platforms.

11. A launching container assembly comprising:
first and second mobile platforms; and
a container extending a length from a first end to a second end, the container comprising an interior compartment that is configured to receive a stack of the first and second mobile platforms therein, the first end of the container comprises an opening configured to enable the first and second mobile platforms to be sequentially launched from the interior compartment of the container through the opening, wherein the first mobile platform rests on the second mobile platform within the interior compartment.

12. The launching container assembly of claim 11, wherein at least one of:
the first and second mobile platforms are configured to mate together; or
the first and second mobile platforms nest with each other within the stack.

13. The launching container assembly of claim 11, wherein each of the first and second mobile platforms comprises a propeller assembly having a propeller and a boot positioned thereunder, wherein the boot of the first mobile platform comprises a mating feature for detachably connecting to a top of the propeller assembly of the second mobile platform.

14. The launching container assembly of claim 11, wherein the container comprises a support extending within the interior compartment, the support being configured to engage in physical contact with the first mobile platform to hold the first mobile platform within the interior compartment of the container.

15. The launching container assembly of claim 11, wherein the container comprises a support that includes a fin extending within the interior compartment along at least a portion of the length of the container, the fin extending from an interior side of the container radially inwardly toward a central longitudinal axis of the container, the fin being configured to be received within a groove of each of the first and second mobile platforms.

16. The launching container assembly of claim 11, wherein the container comprises a support extending within the interior compartment, wherein the support comprises at least one of a lateral support that extends radially inwardly within the interior compartment of the container, a break-away connector, a hinge, a magnet, a magnetic connector, a latch, a clearance fit connector, an interference fit connector, a press fit connector, a pressure connector, a clamp, or a snap fit connector.

17. The launching container assembly of claim 11, wherein the container comprises a support that is configured to be connected to the first mobile platform to hold the first mobile platform within the interior compartment, the support being configured to release from the first mobile platform to enable the first mobile platform to be launched from the interior compartment of the container.

18. A method comprising:
configuring a launching container for launch, wherein the launching container contains a stack of first and second mobile platforms; and
sequentially launching the first and second mobile platforms from the launching container.

19. The method of claim 18, wherein configuring the launching container for launch comprises at least one of orienting the launching container, positioning the launching container, transporting the launching container, removing at least one of a cover or a lid of the launching container, or installing the stack of the first and second mobile platforms within the launching container.

20. The method of claim 18, wherein sequentially launching the first and second mobile platforms from the launching container comprises flying the first and second mobile platforms through an exit of the launching container.
